(19) United States
(12) Patent Application Publication
(10) Pub. No.: US 2016/0034289 A1
(43) Pub. Date: Feb. 4, 2016

(54) COMPUTER SYSTEM AND PROCESSING METHOD OF THE SAME

(71) Applicant: HITACHI, LTD., Tokyo (JP)

(72) Inventors: Takashl AMANO, Tokyo (JP); Atsumi TERAYAMA, Tokyo (JP); Toru TANAKA, Tokyo (JP)

(73) Assignee: Hitachi, Ltd., Tokyo (JP)

(21) Appl. No.: 14/424,945

(22) PCT Filed: Dec. 16, 2013
(86) PCT No.: PCT/JP2013/083625

§ 371 Date: Feb. 27, 2015

(51) Int. Cl. G06F 9/455; G06F 11/34; G06F 9/50; G06F 11/30

(52) U.S. Cl. CPC G06F 9/45558; G06F 11/30; G06F 11/34; G06F 9/5027; G06F 2009/45591

(57) ABSTRACT

A computer system including a peripheral equipment and a blade server provided with a plurality of blades, which are physical machines, and a plurality of virtual machines available on the blades, a same OS identifier is allocated, before and after the migration, to an OS that migrates along with migration of the virtual machine, migrates among the plurality of virtual machines or migrates between the virtual machine and the blade, and log of the blades and/or the virtual machines, and log of the peripheral equipment are stored in association with the OS identifier.

### TECHNICAL FIELD

The present invention relates to a computer system and its processing method.

### BACKGROUND ART

To enhance the resource utilization efficiency of physical machines, virtual machines (hereinafter abbreviated to VM) are in extensive use at data centers and elsewhere. However, in some cases, VMs cannot provide necessary processing performance for business application. In such a case, instead of using VMs, physical machines are directly used. This has resulted in mixed presence of VMs and physical machines within a system. Furthermore, migration of business applications and OS (operating system) from a VM to a physical machine for performance improvement and from a physical machine to a VM for enhancement of resource utilization efficiency has also come into practice.

In this context of increasing mixed presence of VMs and physical machines in systems, identification of the cause of trouble or the like in a system requires a log related to VMs and physical machines. Techniques regarding such a log include one of recording of a VM identifier in log information on a physical machine in which the VM is operating, which is disclosed in Patent Literature 1.

### CITATION LIST

### Patent Literature

Patent Literature 1: U.S. Patent Application Publication No. 2010/0332661

### SUMMARY OF INVENTION

### Technical Problem

In a system, there are many items of peripheral equipment including Ether (Ethernet®) switches, FC (Fibre Channel) switches and storage devices in addition to server items including VMs and physical machines, and the logs of these items of peripheral equipment run up to a tremendous volume. When performance deterioration or any other abnormality of a specific VM or physical machine is noticed and it is attributable to trouble with any peripheral equipment, identification of the failure will require extraction of the log of peripheral equipment related to a specific VM and physical machine.

In respect of such troubles, the technique disclosed in Patent Literature 1 can record log information, but, since no relevance of the VM and physical machine to peripheral equipment is taken into account, it is unable to extract the log of peripheral equipment relevant to a specific VM and physical machine out of the tremendous volume of logs.

Then, one of the objects of the present invention is to extract and display the log of a specific VM and physical machine and the log of peripheral equipment relevant to the specific VM and physical machine out of the tremendous volume of logs.

### Solution to Problem

A computer system according to the present invention includes a peripheral equipment and a blade server provided with a plurality of blades, which are physical machines, and a plurality of VMs (virtual machines) available on the blades. A same OS identifier is allocated, before and after the migration, to an OS that migrates along with migration of the VM, migrates among the plurality of VMs or migrates between the VM and the blade. And log of the blades and/or the VMs, and log of the peripheral equipment are stored in association with the OS identifier.

In the computer system according to the present invention, upon acceptance of choice of the blade or the VM, the OS identifier allocated to the OS having operated with the chosen blade or VM is specified, and the log of the peripheral equipment in association with the specified OS identifier is outputted.

The invention is also perceived as a processing method for the computer system.

### Advantageous Effects of Invention

According to the present invention, it is possible to extract and display the log of a VM and a physical machine and the log of peripheral equipment relevant to the VM and physical machine out of the tremendous volume of logs, and to readily perceive the log of peripheral equipment relevant to the VM and physical machine.

### BRIEF DESCRIPTION OF DRAWINGS

FIG. 1 is a diagram showing an example of log display screen.

FIG. 2 is a diagram showing an example of system configuration.

FIG. 3A is a diagram showing an example of a first part of configuration management table.

FIG. 3B is a diagram showing an example of a second part of configuration management table.

FIG. 4 is a diagram showing an example of OS ID management table.

FIG. 5 is a diagram showing an example of log of a virtualization control program.

FIG. 6 is a diagram showing an example of tag management table.

FIG. 7 is a diagram showing an example of log management table.

FIG. 8 is a diagram showing an example of tag attachment processing.

FIG. 9 is a diagram showing an example of log deletion processing.

FIG. 10 is a diagram showing an example of temporary OS ID management table.

FIG. 11 is a diagram showing an example of resource matching management table.

### DESCRIPTION OF EMBODIMENTS

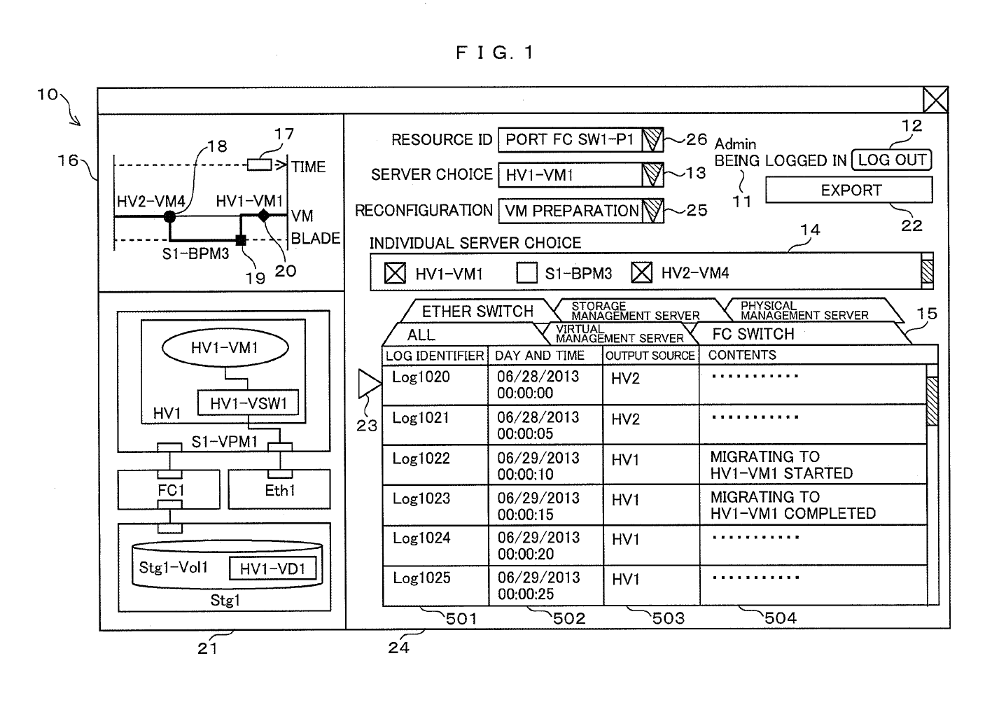

This embodiment will be outlined with reference to FIG. 1. In the embodiment, log displaying is accomplished from the viewpoint of VMs and physical machines. With the alteration log for peripheral equipment items related to the VMs and physical machines, OS identifiers and reconfiguration identifiers, which are the same for each set of VM and physical machine, are associated. Since the description of this embodiment takes up a blade type physical machine by way of example, the physical machine is supposed to be a blade. For instance, each log management program associates the OS identifier and the reconfiguration identifier with the log of processing accomplished with a storage device, virtualization blade, Ether switch or FC switch at the time of VM preparation. A log with which an OS identifier is associated is prioritized in conservation instead of being deleted.

And when the manager chooses with server choice 13 the VM or blade whose log is desired to be displayed, only the log related to the VM or blade is extracted by the OS identifier and displayed on a log display 15. Such displaying is particularly effective for identifying in trouble cause analysis a log of peripheral equipment related to the VM or blade or, conversely, in identifying the log of a VM or blade related to peripheral equipment.

Since this embodiment enables a required log related to the VM or blade to be extracted instead of being deleted, log analysis can be easily performed. Even if this results in a large system scale and an increase in the variety and quantity of logs, logs related to the VM or blade can be extracted for extraction, and accordingly the workload of the manager can be reduced and the time spent on analysis shortened. This enables the cost of management to be saved accordingly.

Even in cloud service, a drop in service level due to trouble may prove fatal. By analyzing the trouble swiftly, it becomes possible to provide stable service to users. The users are enabled to utilize cloud service without worry.

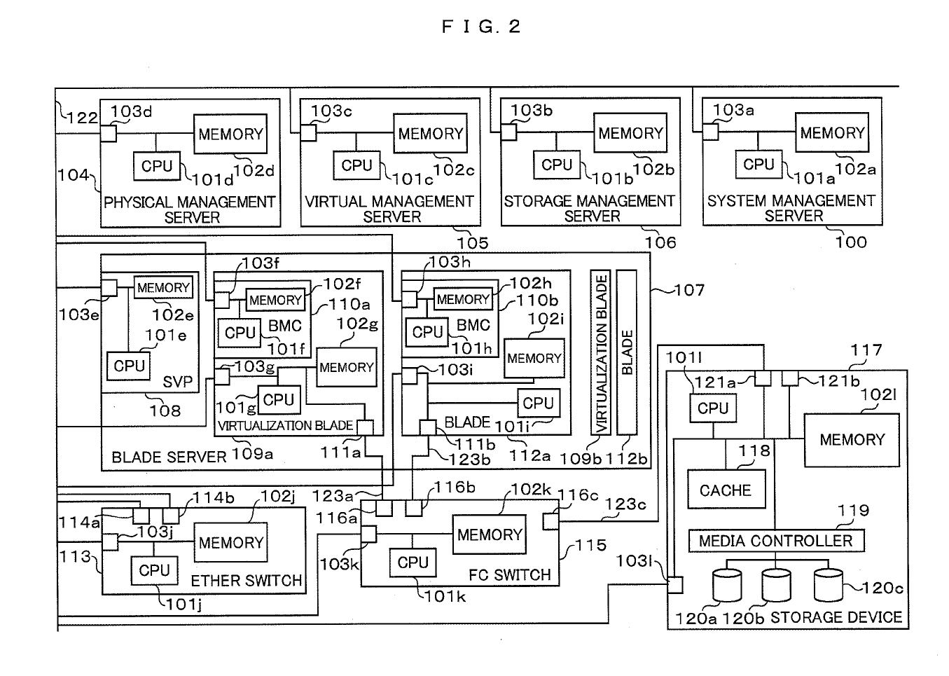

FIG. 2 is a diagram showing a preferable example of system configuration of this embodiment. Equipment items or the like denoted by the same signs in FIG. 2 function similarly as hardware, but if they differ in the program to be executed or the data to be handled, the sign will be supplemented at the end with a Roman letter. No such Roman letter will be added for common descriptions, though a Roman letter will be added where the description distinguishes a particular item from others.

A system management server 100 is configured of a CPU 101a, a memory 102a and an Ether I/F 103a. The CPU 101 executes programs stored in the memory 102. The memory 102 stores programs, management tables and logs. The Ether I/F 103 is a device that communicates by TCP/IP protocol via connected equipment and an Ether net 122. IP addresses necessary for communication are stored in the memory 102.

The memory 102a holds a system management program, a system log management program, an OS ID management table 400, a configuration management table 300, an Ether switch the tag management table 600j, an FC switch the tag management table 600k, a log management table 700a, an Ether switch log 500j, an FC switch log 500k, the resource matching management table 1100j of the Ether switch and the resource matching management table 1100k of the FC switch.

The system management program displays a GUI for reconfiguring the system. Using the GUI, the manager instructs the system management program to delete VMs, allocate a blade 112 and so forth. The system log management program also performs processing regarding logs.

A physical management server 104 is configured of a CPU 101d, a memory 102d and an Ether I/F 103d. The memory 102d holds a blade management program, a blade log management program, a blade management table, a log 500d, a the tag management table 600d, a log management table 700d and a resource matching management table 1100d.

The blade management program, intended for managing a plurality of blade servers 107, acquires information of an SVP management table from an SVP 108 at the time of reconfiguration, and stores it into the blade management table. Also, the blade management program receives logs from the SVP 108.

The blade log management program attaches tags to logs. Herein, associating an OS identifier and so forth is referred to as “to attach a tag”.

A virtual management server 105 is configured of a CPU 101c, a memory 102c and an Ether I/F 103c. The memory 102c holds a VM management program, a VM log management program, a virtual management table, a log 500c, a the tag management table 600c, a log management table 700c and a resource matching management table 1100c.

The VM management program acquires information of a VM configuration management table from the virtualization control program of a virtualization blade 109 at the time of reconfiguration, and stores it into the virtual management table. Also, the VM management program receives logs from the virtualization control program. The VM log management program attaches tags to logs.

A storage management server 106 is configured of a CPU 101b, a memory 102b and an Ether I/F 103b. The memory 102b holds a storage management program, a storage log management program, a storage management table, a log 500b, a tag management table 600b, a log management table 700b and a resource matching management table 1100b.

The storage management program acquires information of a storage configuration management table from the storage control program of a storage device 117 at the time of reconfiguration, and stores it into the storage management table. The storage management program receives logs from the storage control program. The storage log management program attaches tags to logs.

The blade servers 107 are configured of the SVP 108 and a plurality of blades. The SVP 108 is configured of a CPU 101e, a memory 102e and an Ether I/F 103e. The memory 102e holds an SVP control program, an SVP management table and logs. The SVP control program acquires information of a BMC configuration management table from the BMC control program of a BMC (Base Management Controller) at the time of reconfiguration, and stores it into the SVP management table. The SVP control program receives logs from the BMC control program.

The virtualization blade 109 is a blade operated by the virtualization control program. The virtualization blade 109 provides a virtual environment in which a plurality of VMs can be prepared by the virtualization control program. The manager can install an OS into each VM. Other resources of the blade than the BMC 110 (CPU 101, memory 102, Ether I/F 103, FC I/F 111) are shared among VMs.

The manager can install one OS by using the blade 112 when, for instance, performance is given priority. In this process, the resources of the blade 112 are occupied by the single OS.

The virtualization blade 109a is configured of a BMC 110a, a CPU 101g, a memory 102g, an Ether I/F 103g and an FC I/F 111a. A BMC 110 is configured of a CPU 101, a memory 102 and an Ether I/F 103.

The memory 102 of the BMC 110 holds the BMC control program, the BMC configuration management table and logs. The BMC control program transmits information of the BMC configuration management table and logs to the SVP control program. The memory 102g holds the virtualization control program, the VM configuration management table and logs. The virtualization control program transmits information of the VM configuration management table and logs to the VM management program, and prepares, deletes, starts or stops a VM.

A blade 112a is configured of a BMC 110b, a CPU 101i, a memory 102i, an Ether I/F 103i and an FC I/F 111b. The memory 102i holds the OS.

An Ether switch 113 is configured of a CPU 101j, a memory 102j, an Ether I/F 103j and an Ether I/F 114. The Ether I/F 103j is used as an I/F for managing the Ether switch 113. The Ether I/F 114 is a device for communication between other equipment items by the TCP/IP protocol via the Ether switch 113. The memory 102j holds an Ether switch control program, an Ether switch configuration management table and logs. The Ether switch control program transmits information of the Ether switch configuration management table and logs to the system management program, and performs VLAN setting of the Ether I/F 114.

An FC switch 115 is configured of a CPU 101k, a memory 102k, an Ether I/F 103k and an FC I/F 116. The memory 102k holds a FC switch control program, an FC switch configuration management table and logs. The FC I/F 116 is a device for communication between other equipment items by the FC protocol via the FC switch 115. The FC switch control program transmits information of the FC switch configuration management table and logs to the system management program, and sets zoning of the FC switch 115.

The storage device 117 is configured of a CPU 101l, a memory 102l, an Ether I/F 103l, a cache 118, an FC I/F 121, a media controller 119 and memory media 120. The cache 118 is a device for temporarily holding volume data. The FC I/F 121 is a device for communication with connected equipment items by the FC protocol. The media controller 119 is a device connected to a plurality of memory media 120 to relay data reading and writing from and into the memory media 120. The memory media 120 are devices for preserving data, and may be hard disks or SSD (Solid State Drives) for instance.

The memory 102l holds the storage control program, the storage configuration management table and logs. The storage control program configures RAID (Redundant Arrays of Inexpensive Disks) out of a plurality of memory media 120 to prepare volumes, which are logical memory media. In this connection, the storage management program of the storage management server 106, to enable the virtualization blade 109 to detect volumes, sets a host group that manages authentication of access to the volumes. Further, the storage control program transmits information of the storage configuration management table and logs to the storage management program. To add, it is possible for a single volume to contain a plurality of virtual disks, and a single VM to access a single virtual disk and a plurality of VMs to access a single volume.

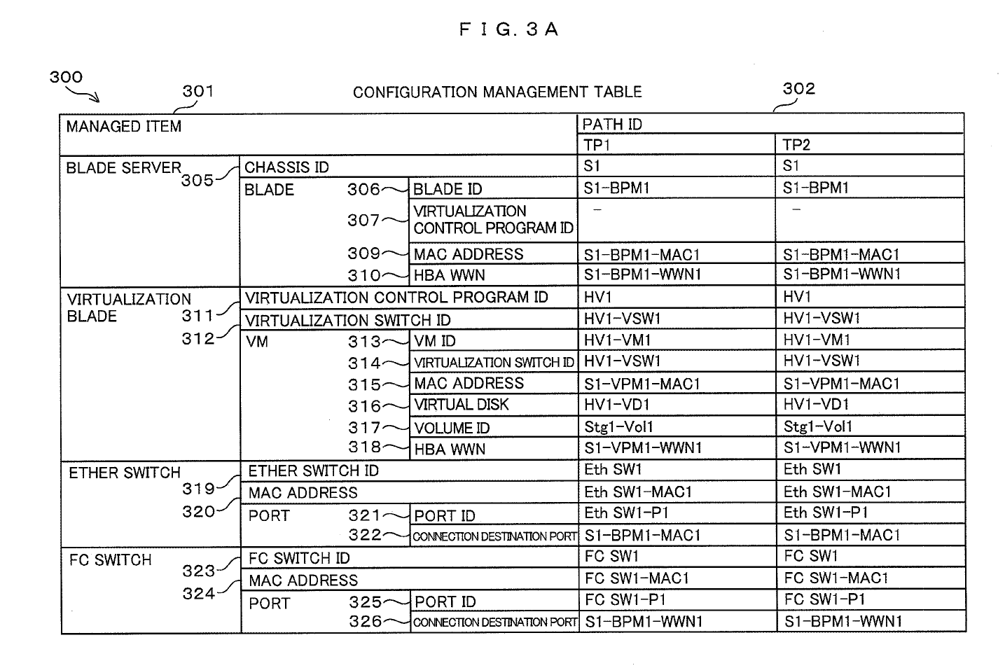

FIGS. 3A and 3B are diagrams showing examples of configuration management table 300. The configuration management table 300 is configured of managed items 301 and path IDs 302. The managed items 301 are configuration items that are to be managed and, on the basis of these items, the system log management program acquires information of the blade management table from the blade management program as configurative information on the blade servers 107. The system management program acquires information of a virtual management table from the VM management program as configurative information on the virtualization blade 109. The system management program acquires information of the Ether switch configuration management table from the Ether switch control program as configurative information on the Ether switch 113. The system management program acquires information of the FC switch configuration management table from the FC switch control program as configurative information on the FC switch 115. The system management program acquires information of a storage management table from the FC switch 115 as configurative information on the storage device 117.

A chassis ID 305 is an identifier for identifying a blade server. A blade ID 306 is an identifier for identifying a blade. A virtualization control program ID 307 is an identifier for identifying a virtualization control program. A MAC address 309 is an identifier for identifying the Ether I/F 103 of a blade. An HBA WWN 310 is an identifier for identifying the FC I/F 111.

A virtualization control program ID 311 is an identifier for identifying the virtualization control program operated by a blade. A virtual switch ID 312 is an identifier for identifying a virtual switch operated by the virtualization control program for blade-by-blade communication. A VM ID 313 is an identifier for identifying a VM operated by the virtualization control program. A virtual switch ID 314 is the ID of a virtual switch to which VMs are connected for inter-VM communication. A MAC address 315 is the MAC address of the Ether I/F 103 allocated to the virtual switch ID 314. A virtual disk 316 is an identifier for identifying a virtual disk connected to a VM. A volume ID 317 is an identifier for identifying a volume connected to a VM. A HBA WWN 318 is a WWN (World Wide Name) as an identifier for identifying the FC I/F 111 having detected a volume used by a VM.

An Ether switch ID 319 is an identifier for identifying the Ether switch 113. A MAC address 320 is an identifier for identifying an Ether I/F 103j. A port ID 321 is an identifier for identifying the Ether I/F 114. A connection destination port 322 is the MAC address of equipment connected to the Ether I/F 114.

An FC switch ID 323 is an identifier for identifying the FC switch 115. A MAC address 324 is the MAC address of the Ether I/F 103k. A port ID 325 is an identifier for identifying the FC I/F 116. A connection destination port 326 is the WWN of a port connected to the FC I/F 116.

A storage ID 327 is an identifier for identifying the storage device 117. The WWN 328 of the port is an identifier for identifying the FC I/F 121. A volume ID 329 is an identifier for identifying a volume. A host group ID 330 is an identifier for identifying a host group. A WWN 331 of HBA is the WWN of the FC I/F 111 that detects a volume. A volume ID 332 is the volume ID 329 set for the host group.

The path ID 302 is an identifier for identifying the generation of system configuration. TP1 denotes the first generation and TP2, the second generation. The system management program, upon completing an instruction for system reconfiguration inputted from the manager, acquires and updates configurative information, newly allocates a path ID 302, and stores it into the configuration management 300. The system management program, if the instruction for system reconfiguration from the manager includes a plurality of reconfiguration processes, may as well execute this processing on the configuration management table 300 upon completion of each individual reconfiguration process.

By performing association as will be described below and reference information on partners to association, configuration of connection of a given VM or blade 112 to peripheral equipment can be acquired. The system management program, when allocating the virtualization blade 109, installs the virtualization control program among others into the blade. Association of the blade with the virtualization control program is done on this occasion; the virtualization control program ID 307 represents the virtualization control program operated by the blade. Out of the virtual switch IDs 312, the virtual switch ID used by a VM is stored in the virtual switch ID 314. Out of MAC addresses 309, the MAC address used by a VM is stored in the MAC address 315. Out of the volume IDs 329, the volume ID used by a VM is stored in the volume ID 317.

Out of the HBA WWNs 310, the HBA WWN used by a VM is stored in the HBA WWN 318. The ID of a virtual disk prepared for a VM of the VM ID 313 is stored in the virtual disk 316. Out of the MAC addresses 309, the MAC address to be connected to a port to which the port ID 321 is allocated is stored into the connection destination port 322. Out of the HBA WWNs 310 or the WWNs 328 of ports, the HBA WWN to which the port ID 325 is allocated or the WWN of a port is stored into the connection destination port 326. Out of the HBA WWNs 310, the HBA WWN set for the host group is stored into the WWN 313 of HBA. Out of the volume IDs 329, the volume ID set for the host group is stored into the volume ID 332.

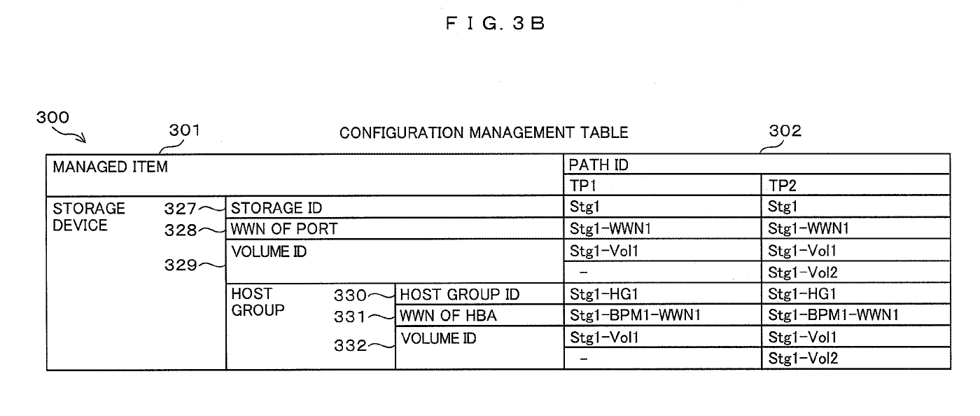

FIG. 4 is a diagram showing an example of OS ID management table 400. The OS ID management table 400 is configured of OS ID 401, number of migrations 402, day and time 403, processing 404 and migration destination ID 405. The OS ID 401 is an identifier for identifying the OS within the system. The number of migrations 402 is the number of times the OS was migrated after server preparation. The day and time 403 is the day and time of execution of the processing 404.

The processing 404 includes VM preparation, blade allocation, VM migration, P2P, V2P, P2V, V2V, VM deletion and blade deallocation. In the processing of VM preparation, VM preparation, preparation of virtual disks for use by VMs, OS installation into VMs, and initial setting of host name and IP address for communication with another OS are done. In blade allocation, in the case of SAN boot, preparation of volumes for use by the blade server and connection setting, OS installation into the blade server and initial setting of host name and IP address for communication with another OS are done. In the processing of VM migration, migration of a VM involving operation of the OS between virtualization blades is done. In P2P processing, OS migration from one blade server to another is done. In V2P processing, OS migration from a VM to the blade server another is done. In P2V processing, OS migration from the blade server to a VM is done. In V2V processing, OS migration from one VM processing, OS migration from one is done. To add, where any application is installed in the OS, the objects of migration include the application. In the processing of VM deletion, a VM and the virtual disk (OS) used by the VM are deleted. In the processing of blade deallocation, deletion of a volume (OS) (in the case of SAN boot, deletion of the volume used by the storage device and unsetting of connection, or in the case of boot from a built-in medium, formatting of the built-in medium) is done. The migration destination ID 405 is an identifier for use in the management of the server at the migration destination.

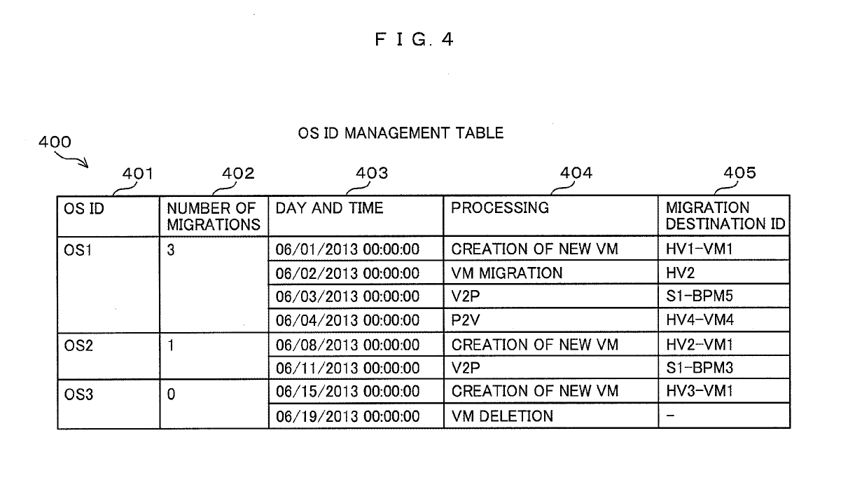

FIG. 5 is a diagram showing an example of log 500g of the virtualization control program. A log 500 is configured of a log identifier 501, day and time 502, an output source 503 and contents 504. The log identifier 501 is an identifier identifying one log. The day and time 502 denotes the day and time when the log was outputted. The output source 503 is an identifier identifying the equipment having outputted the log. The contents 504 indicate the contents of the log.

The Ether switch control program transmits the log 500j of the Ether switch 113 to the system management program after executing the processing of the Ether switch control program. The FC switch control program transmits the log 500k of the FC switch to the system management program after executing the processing of the FC switch control program. The system management program stores the received log 500 into the memory 102a.

The virtualization control program transmits the log 500g of the virtualization control program to the VM management program after executing the processing of the virtualization control program. The VM management program stores the received log 500g and the log of the VM management program into the memory 102c as the log 500c.

The BMC control program transmits the log 500f and the log 500g of the BMC 110 to the SVP control program after executing the processing of the BMC control program. The SVP control program stores the received log 500g and the log 500 of the SVP control program into the memory 102e as the log 500e.

The SVP control program transmits the log 500e of the SVP 108 to the blade management program after executing the processing of the SVP control program. The blade management program stores the received log 500e and the log of the blade management program into the memory 102d as the log 500d.

The storage control program transmits the log 500l of the storage device 117 to the storage management program after executing the processing of the storage control program. The storage management program stores the received log 500l and the log of storage management program into the memory 102b as the log 500b. To add, the log 500 contains information logged in and logged out to cause various items of equipment to execute processing.

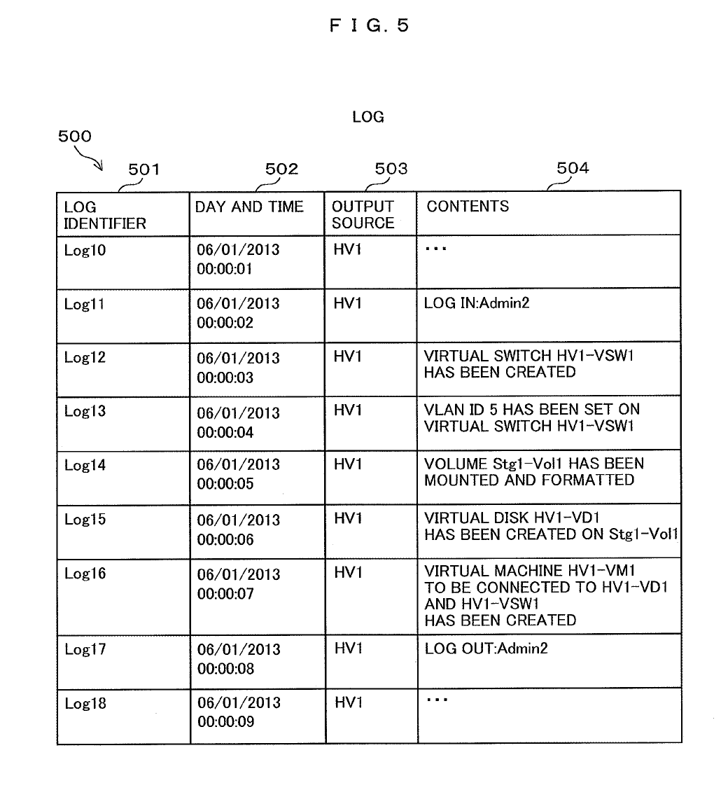

FIG. 6 is a diagram showing an example of the tag management table 600. The tag management table 600 is configured of the log identifier 501, the OS ID 401, the path ID 302 and a reconfiguration ID 601. The tags attached to the log 500 are the OS ID 401, the path ID 302 and the reconfiguration ID 601. The log identifier 501 is a log identifier to which a tag is to be attached. The OS ID 401 is a log-related OS ID. The path ID 302 is a log-related path ID. The reconfiguration ID 601 is an ID for identifying log-related reconfiguration. The reconfiguration ID 601 is set for each process of reconfiguration that the manager can execute. Reconfiguration processes and the reconfiguration IDs matching them are stored into the memory 102a of the system management server 100. The system log management program transmits the reconfiguration ID 601 to each individual log management program as required at the time of executing reconfiguration.

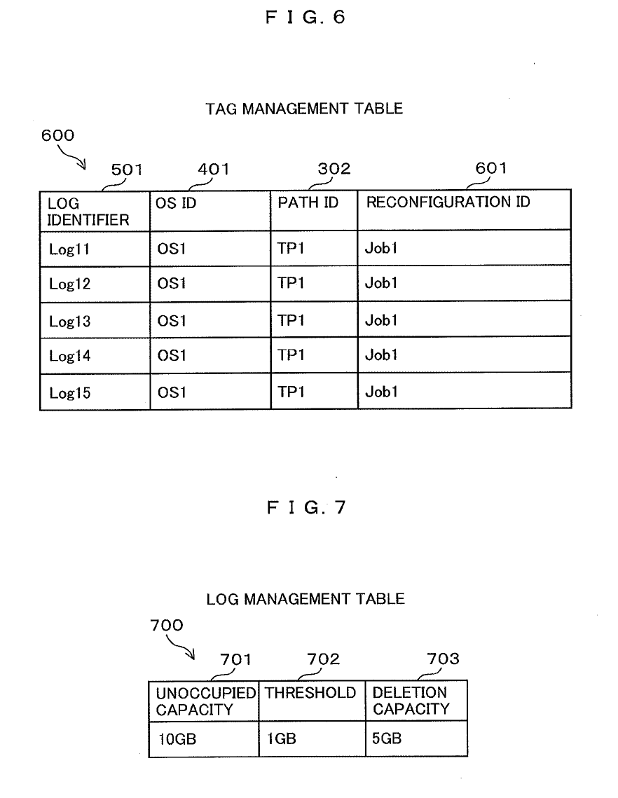

FIG. 7 is a diagram showing an example of log management table 700. The log management table 700 is configured of an unoccupied capacity 701, a threshold 702 a deletion capacity 703. The unoccupied capacity 701 is the unoccupied capacity of memory media storing logs. Log management programs (system log management program, blade log management program, VM log management program and storage log management program) periodically update the unoccupied capacity 701. The threshold 702 is the value of the unoccupied capacity below which log deletion is executed. The deletion capacity 703 is the volume of logs deleted by log deletion processing.

FIG. 1 is a diagram showing an example of log display screen 10. The system log management program displays the log display screen 10 when an instruction to display GUI from the manager is inputted. The log display screen 10 is configured of a log display part 24, a server type display part 16 and a topology display part 21.

A log-in user name 11 represents the user who has logged in to operate the log display screen. A log-out button 12 is a button for the user to log out. A server choice 13 is a pull-down for choosing the server desired for use in log displaying. An initial value means a state in which nothing is chosen. The range of choice includes the VM ID 313 and the blade ID 306 stored in the migration destination ID 405. When a resource ID is selected by a resource ID 26, the system log management program transmits the resource ID to individual log management programs. Each log management program transmits an OS ID 1102 matching the same resource ID to the system log management program. The system log management program acquires a migration destination ID 405 matching the same OS ID 401 as the received OS ID. The system log management program prevents display of anything other than the VM ID 313 and the blade ID 306 stored in the acquired migration destination ID 405.

In an individual server choice 14, the VM or the blade 112 stored in the migration destination ID 405 having the same OS ID as the server chosen by the server choice 13 is displayed. The system log management program displays a log regarding the server chosen here on the log display 15. The log display 15 is configured of a tab displaying every log regarding the server chosen by the individual server choice 14, a tab displaying a log regarding the physical management server, a tab displaying a log regarding the virtual management server, a tab displaying a log regarding the storage management server, a tab displaying a log regarding the Ether switch and a tab displaying a log regarding the FC switch. Each tab is configured of the log identifier 501, the day and time 502, the output source 503 and the contents 504.

The system log management program references the OS ID management table 400, and identifies the OS ID 401 of the server chosen by the server choice 13. The system log management program references the system configuration management table 300, and identifies the path ID of the server chosen by the individual server choice 14. The system log management program acquires the log 500 having the tag of the OS ID 401 and the path ID 302, which have been identified, from the physical management server 104, the virtual management server 105, the storage management server 106 and the system management server 100, and displays the log.

A cursor 23 indicates the currently chosen row of the log. The topology display part 21 displays the topology at the point of time when the log indicated by the cursor 23. The system log management program displays on the topology display part 21 the connective relations among the server, the virtual switch (applies only to VM), the virtualization blade (applies only to VM), the Ether switch, the FC switch, the storage device, the volume and the virtual disk (applies only to VM).

In a server type display part 16, the right side shows the display range of the log and the server type in a time series constituting a new time scale. A display range 17 shows the range of logs displayed in the log display 15. This is interlocked with the log display 15; when it is slid left and right, the log at the time is displayed on the log display 15. When the log indication on the log display 15 is slid up and down, the display range 17 shifts according to the time. Under the display range, server types are displayed in the time series, and marks of V2P 18, P2V 19 and V2V 20 are also displayed.

An export 22 is a button for outputting the original log to a file. The system log management program may acquire the tag management table 600 when outputting a tag and output the log and information of the tag management table 600.

A reconfiguration 25 is so designed as to enable an operation the manager can instruct the system log management program to be chosen by pull-down. An initial value means a state in which nothing is chosen. When some operation is chosen, only a log with which a tag corresponding to that operation is matched is displayed on a log display tab regarding the VM and the blade chosen by the server choice 13. When the reconfiguration 25 is chosen, the system log management program acquires from the memory 102a the reconfiguration ID matching the chosen reconfiguration, and transmits it to each log management program.

Each log management program references the tag management table 600, and identifies the log identifier 501 matching the same reconfiguration ID 601 as the received reconfiguration ID. Each log management program acquires the log 500 matching the log identifier 501 and transmits it to the system log management program. The system log management program displays the received log 500 on the log display 15. When the reconfiguration 25 is chosen in a state in which neither a VM nor a blade is chosen by the server choice 13, a reconfiguration log is displayed regarding every server. This is an exemplary case where a log matched with a designated tag is extracted and displayed. The resource ID 26 is in a state of being able to choose any of the resource IDs in the resource matching management table 1100. It is a state in which no initial value is chosen. The system log management program may transmit a log or a log and information of the tag management table 600 to another log management server. On this occasion, filtering may be done with the OS ID 401 or some other tag.

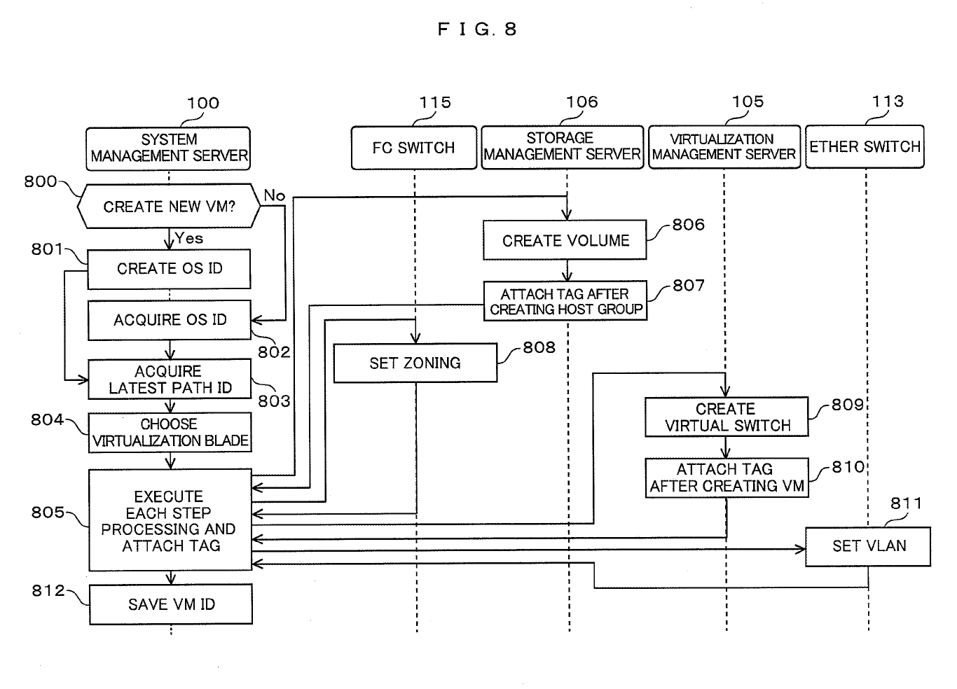

FIG. 8 is a diagram showing an example of processing of tag attachment. Tag attachment processing is executed at an instruction from the manager to prepare a VM or allocate a blade, or at an instruction to process with the VM or the blade 112 designated.

Step 800: The system management program determines whether or not an instruction from the manager requires preparation of a new VM. If Yes, Step 801 is processed, or if No, Step 802 is processed.

Step 801: The system log management program newly prepares the OS ID 401 and stores it into the OS ID management table 400. The system log management program acquires that OS ID 401. The OS ID 401 may as well be prepared in advance.

Step 802: When at P2V for instance, the system log management program references the OS ID management table 400 with the identifier of the blade of the migration source inputted from the manager to identify and acquire the OS ID 401.

Step 803: The system log management program acquires from the memory 102a the reconfiguration ID matching an instruction from the manager. The system log management program acquires the latest path ID 302 from the configuration management table 300. This processing may as well be done immediately before giving instructions to the storage management program, the virtual management program, the blade management program, the Ether switch control program, the FC switch control program and the storage management program.

Step 804: The system management program chooses one of the virtualization blades 109 registered with the latest path ID 302 in the configuration management table 300.

Step 805: The system log management program transmits the OS ID 401, the path ID 302 and the reconfiguration ID to the blade log management program, the VM log management program and the storage log management program. And at Step 805, the following processing is done in conjunction with Steps 806 to 811.

The system management program instructs the storage management program to prepare a volume in which virtual disks of VMs are to be stored. On this occasion, the system management program transmits, to the storage management program, the storage device 117 in which the volume is to be prepared, the capacity of the volume, the WWN of the FC I/F 111 of the selected the virtualization blade 109 and the WWN of the FC I/F 121 in which the host group is to be set.

Also, the system management program gives a zoning instruction to the FC switch control program after receiving a notice of processing completion from the storage management program. On this occasion, the system management program transmits the WWN of the virtualization blade 109 and the WWN of the FC I/F 121 of the storage device 117.

The system log management program monitors the log 500k of the FC switch 115, and acquires a log 500k newly stored into the memory 102a. The system log management program acquires the log identifiers 501 of the logs from where the user logged in to where he or she logged out. The system management program stores the log identifier 501, the OS ID 401, the path ID 302 and the reconfiguration ID 601 into the tag management table 600k. These steps of processing to monitor the log 500, acquire a new log 500, acquire the log identifier 501s of the logs from where the user logged in to where he or she logged out, and store the log identifier 501, the OS ID 401, the path ID 302 and the reconfiguration ID 601 into the tag management table 600 are supposed to constitute tag attachment processing.

Each log management program updates the resource matching management table 1100 after the processing of tag attachment. Each log management program stores into the OS ID 1102 the OS ID 401, which is the object of reconfiguration matching the resource ID 1101. Each log management program identifies the resource IDs 1101 of other logs than those that the tag attaching user logged in and logged out, acquires the OS ID 1102 matching the resource ID 1101 of the resource matching management table 1100 and the path ID of the system configuration management table 300, and stores them into the tag management table 600. On this occasion, the reconfiguration ID 601 is left blank. Identification of the resource ID of each log is accomplished by a way of filtering matching the log form of each individual equipment item. Filtering information is stored into the memory 102 in advance.

Usually, a program authenticates the user when processing is to be executed with hardware. Tag attachment is executed in units matching the user authentication. The processing is exclusively executed to avoid parallel execution. Although each individual log management program is supposed to process tag attachment here, the logs 500 may unilaterally collected into the system management server 100 to cause the system log management program to process tag attachment. This alternative has the effects of making unnecessary the time taken by log transmission via the network at the time of log displaying and increasing the speed of log displaying correspondingly.

The system management program instructs the VM management program to prepare a virtual switch (in the absence of a virtual switch to which a VM is to be connected) after receiving a notice of processing completion from the FC switch control program. On this occasion, the system management program transmits a virtualization control program ID and a VLAN ID.

Also, the system management program instructs the VM management program to prepare a VM after receiving a notice of processing completion from the VM management program. On this occasion, the system management program transmits necessary information for VM preparation including the virtualization control program ID, the virtual switch ID, the WWW of the HBA that detects the volume, the volume ID and the virtual disk capacity.

The system management program instructs the Ether switch control program to set a VLAN ID after receiving a notice of processing completion from the VM management program. On this occasion, the system management program transmits the VLAN ID. The system log management program processes tag attachment to the log 500j for which the VLAN ID has been set.

Following the processing at Step 805 so far described, Steps 806 to 811 will be described below.

Step 806: The storage management program instructs the storage control program to prepare a volume in the storage device 117. The storage control program transmits the log 500l of this processing to the storage management program. The storage log management program processes tag attachment to the log 500l in which the volume has been prepared.

Step 807: The storage management program sets the WWW of the virtualization blade 109 and the prepared volume in the host group of the FC I/F 121 to enable the virtualization control program to detect the volume. The storage control program transmits the log 500l of this processing to the storage management program. The storage log management program processes tag attachment to the log 500l in which the host group has been set.

Step 808: The FC switch control program sets zoning with the WWN of the virtualization blade 109 and the WWN of the storage device 117. The FC switch control program transmits the log regarding the setting of zoning to the system management program. The system log management program processes tag attachment to the log 500k in which zoning has been set.

Step 809: The virtual management program instructs the virtualization control program of the virtualization blade 109 to prepare a virtual switch and set the VLA ID of that virtual switch. The virtualization control program prepares the virtual switch and sets VLAN. The virtualization control program transmits the log 500g for these steps of processing to the virtual management program. The virtual management program transmits the virtual switch ID received from the virtualization control program having prepared the virtual switch to the system management program. The VM log management program processes tag attachment to the log 500c having prepared the virtual switch.

Step 810: The virtual management program instructs the virtualization control program to prepare a VM. The virtualization control program prepares a virtual disk in a detected volume, and prepares a VM to be connected to the prepared virtual switch. The virtualization control program transmits the log 500g of this processing to the virtual management program. The virtual management program transmits the VM ID received from the virtualization control program to the system management program. The VM log management program processes tag attachment to the log 500c having prepared the VM.

Step 811: The Ether switch control program sets a VLAN ID in each of the Ether I/Fs 114 to enable them to accomplish VM communication. The Ether switch control program outputs the log of this processing.

Step 812: The system management program stores the received VM ID into the OS ID management table 400. This ends the processing of VM preparation of blade allocation.

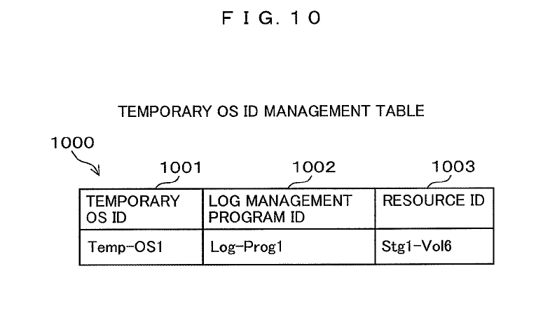

In the foregoing description with reference to FIG. 8, it is supposed that the OS ID can be identified when processing tag attachment. Since the instruction from the manager does not always permit identification of the OS ID, cases where identification of the OS ID is impossible will be described below with reference to FIG. 8 and FIG. 10.

FIG. 10 is a diagram showing an example of temporary OS ID management table. A temporary OS ID management table 1000 is configured of a temporary OS ID 1001, a log management program ID 1002 and the resource ID 1003. The temporary OS ID 1001 is an identifier that is temporarily used when the OS ID 401 is not identified. The log management program ID 1002 is an identifier for identifying the system log management program, the blade log management program, the VM log management program and the storage log management program. The resource ID 1003 is an identifier for identifying the virtualization blade 109 related to the blade 112 or the VM, the Ether I/F 114 of the Ether switch 113, zoning of the FC switch 115, the volume of the storage device 117 or resources including the FC I/F 121.

One example of instruction of the manager only concerns processing to prepare a volume. The system management program starts processing at Step 803. The system management program at Step 803 determines that the temporary OS ID 1001 is to be matched with a log if no OS ID has been acquired, and generates the temporary OS ID 1001, which is unique in meaning in the system.

At Step 805, the system log management program transmits the temporary OS ID 1001, the path ID 302 and the reconfiguration ID to the storage log management program.

In tag attachment processing at Step 806, the storage log management program stores a temporary OS ID, instead of an OS ID, into the tag management table 600. The storage log management program transmits a log management program ID, which distinguishes from itself the resource ID to be processed, to the system log management program.

None of Step 807 to Step 812 is executed, but the new Step 813 next, not charted, is executed. At Step 813, the system log management program stores a temporary OS ID 10001, a log management program ID and the resource ID into the temporary OS ID management table 1000.

Next, processing to allocate a volume to a VM and alter the temporary OS ID into an OS ID will be described with reference to FIG. 8. The instruction of the manager is supposed to require connection of an already prepared volume to a VM to be newly prepared. Step 806 in FIG. 8 is not processed. At Step 812, the system log management program checks whether or not the resource ID 1003 of the temporary OS ID management table 1000 contains the volume ID of the manager-designated volume. If the volume ID is found, the system log management program instructs the log management program matching the log management program ID 1002 to alter the temporary OS ID 1001 to the newly prepared OS ID 401. The system log management program transmits the temporary OS ID 1001 and the prepared OS ID 401 to the corresponding log management program. The instructed log management program alters the temporary OS ID in the tag management table 600 to the prepared OS ID. In the absence of a volume ID, the manager-instructed processing is ended. In this way, the temporary OS ID is altered to the OS ID.

Further, even if the manager's instruction does not designate any VM or blade 112, if it is possible to identify the OS ID 401 by referencing the system configuration management table 300 and the OS ID management table 400, the OS ID 401 is used instead of using the temporary OS ID 1001. And if the manager's instruction enables the resource ID to be specified, every OS ID 401 related to the resource ID may as well be acquired by using the system configuration management table 300 and the OS ID management table 400. Each log management program stores every one of the OS IDs 401 acquired in tag attachment processing into the tag management table 600.

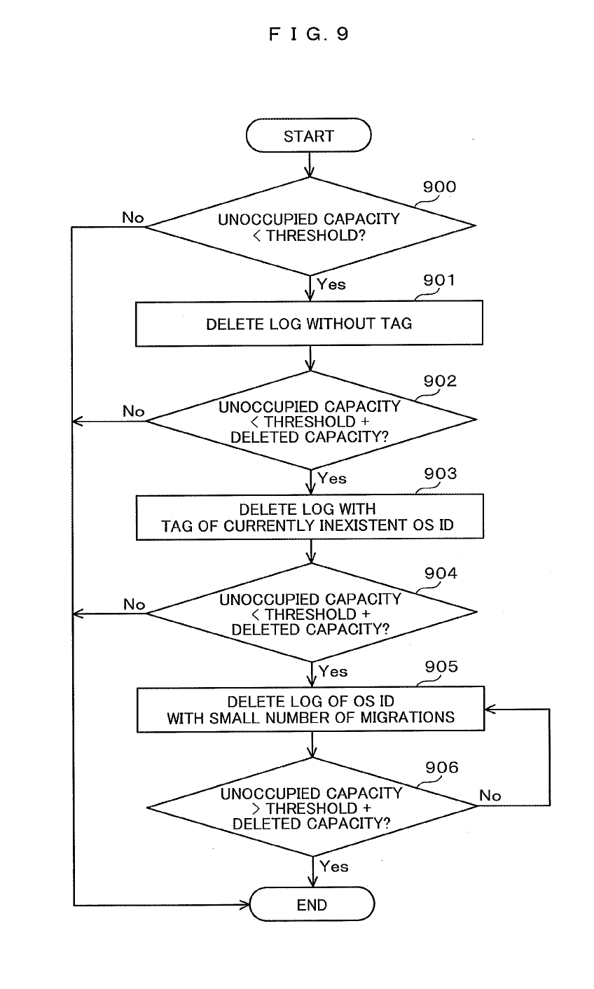

FIG. 9 is a diagram showing an example of log deletion processing. Each log management program periodically executes log deletion processing. The following description will refer to processing regarding one of a number of log management programs.

Step 900: The log management program determines whether or not unoccupied capacity 701 is less than the threshold 702. If Yes, the processing advances to Step 901 or if No, it will be ended.

Step 901: The log management program deletes logs with no tag attached. In this embodiment, logs of peripheral equipment items not associated with the OS have no tag attached.

Step 902: The log management program determines whether or not the unoccupied capacity 701 is less than the total of the threshold 702 and the deletion capacity 703. If Yes, the processing advances to Step 903 or if No, it is ended.

Step 903: The log management program deletes logs with tags of the OS ID 401 already deleted and no longer existent.

Step 904: The log management program determines whether or not the unoccupied capacity 701 is less than the total of the threshold 702 and the deletion capacity 703. If Yes, the processing advances to Step 905 or if No, it is ended.

Step 905: The log management program deletes logs with tags of the OS ID 401 small in the number of migrations 402. In this case, all such logs need not be deleted, but they may be split into parts in the chronological orders and only the part of the oldest logs may be deleted.

Step 906: The log management program determines whether or not the unoccupied capacity 701 is more than the total of the threshold 702 and the deletion capacity 703. If Yes, the processing is ended or if No, it returns to processing at Step 905.

Besides the OS ID 401 and the path ID 302, other various values can be used as tags to be matched with logs. Using diverse values as tags makes possible log displaying from multiple points of view. For instance, when the system is shared by a plurality of tenants, tenant IDs can be used as tags. For example, the system log management program can prepare an OS ID management table 400 and a temporary OS ID management table 1000 for each tenant, and distinguish them by a tenant ID. Each log management program can add tenant IDs and store them into the tag management table 600. The tenant manager, when logging in on the log display screen 10, can display only such logs as are matched with tenant IDs managed by the tenant manager. Limiting the range of logs displayable according to tenant IDs in this way provides the effect of ensuring security. Or individual tenants can be rated on a priority scale (service level), and at Step 905 tenants of the same number of migrations but lower on the priority scale can be deleted from the logs matched with them.

Or where a VM or the OS of a VM, or a blade 112 or the OS of a blade 112, is managed with a specific application, the application ID identifying that application may be used as a tag, and the OS ID 401 and the application may be matched with each other to achieve management by the OS ID management table 400. In tag attachment processing, each log management program [symbol] adds an application ID besides the OS ID 401. When the application under which the VM or the OS of the VM or the blade 112 or the OS of the blade 112 is managed is altered, the system log management program alters the application ID of the OS ID management table 400. Further, the application manager, when logging in on the log display screen 10, can display only such logs as are matched with application IDs managed by the application manager. Or individual applications can be rated on a priority scale (service level), and at Step 905 logs of the same number of migrations but matched with applications lower on the priority scale can be deleted from the logs matched with them. Or at Step 905, logs matched with OS IDs may be deleted in the ascending order of such IDs.

Further, the ID of the user having instructed the system management program to conduct processing may also be used as the tag. In tag attachment processing, each log management program adds the user ID besides the OS ID 401. The manager, when logging in on the log display screen 10, can display can display only such logs as are matched with his or her own user ID. Or individual users can be rated on a priority scale (service level), and at Step 905 users of the same number of migrations but lower on the priority scale can be deleted from the logs matched with them. The system log management program may be caused to collect logs of the OS on VMs; each individual log management program may attach virtual tags to the logs of the virtual switch, the OS on the VM and the virtualization control program, and attach non-virtual tags to the Ether switch 113, the blade 112, the FC switch 115 and the storage device 117. Then at Step 905, only the logs matched with either the non-virtual tags or virtual tags may be deleted. Or at Step 905, the log 500 having given an output may be deleted with the export 22.

Here, processing at Step 901a and Step 902a to be described below may be added between Step 900 and Step 901.

Step 901a: The log management program acquires from other log management programs the balance of subtracting a threshold from the unoccupied capacity 701 managed by each of the other log management programs. An instruction is given to transmit storable logs of not greater than the deletion capacity 703 to such other log management program whose balance is not less than 0 and the greatest, to shift them and store them therein. Each log management program makes such logs distinguishable by classifying them by the log management program that originally managed as to their locations and by assigning IDs. When an individual log management program references logs, it has to reference all the logs previously managed by it by communicating with other log management programs.

Step 902a: The log management program determines whether or not the unoccupied capacity 701 is less than the total of the threshold 702 and the deletion capacity 703. If Yes, the processing returns to Step 901 or if No, it is ended.

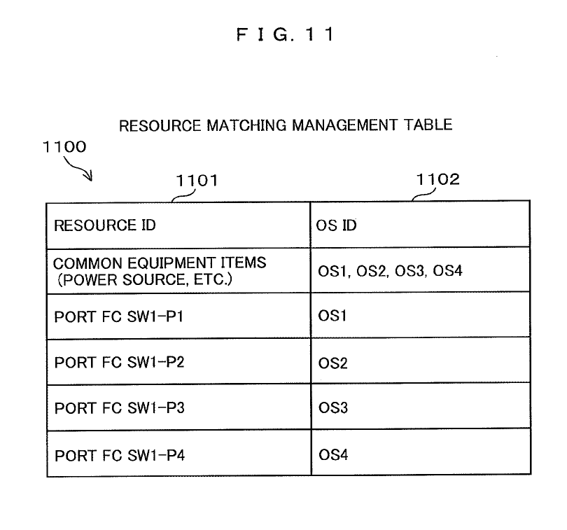

FIG. 11 is a diagram showing an example of resource matching management table 1100. The resource matching management table 1100 is configured of the resource ID 1101 and the OS ID 1102. The resource ID 1101 enables an outputted log to be distinguished as to what constituent part of an equipment item, such as a peripheral equipment item, it concerns and matches the resource ID 1003. The common equipment items entry of the resource ID 1101 indicates that they are resources affecting all others, such as the power source. Each log management program prepares in advance the resource matching management table 1100, and registers under the resource ID 1101 all relevant items at the time of table preparation. The OS ID 1102 is an ID for identifying the OS matched with the resource ID.

The foregoing description supposes that the resource matching management table 1100 was prepared for each of the resource IDs of equipment, but it may as well be prepared only for each equipment item. Individual log management program does not specify the resource ID from the log 500. To add, tag information may as well be set by the manager at his or her own discretion. Also, if a user having logged in on the log display screen 10 can display concerning a plurality of tags, one or more tags may be switchable from one to another on the log display screen 10.

Setting of parameters and other necessary values can be automated by setting default values, but they may as well be set by the manager. For values to be prepared on the way of processing, what are prepared in advance but not yet used may also be used. To logs outputted by the system management program or the tag management program, tag attachment may be similarly processed. Although FIG. 2 shows a configuration having the Ether switch 113 and the FC switch 115, the system configuration may dispense with one or both of the switches.

As hitherto described, by relating logs of peripheral equipment regarding blades as VMs and physical machines with OS identifiers, it is made possible to extract logs of VMs and physical machines and logs of peripheral equipment related to VMs and physical machines from a vast quantity of logs and thereby to grasp peripheral equipment related to VMs and physical machines. Further, by giving priority to leaving logs associated with VMs and blades, logs that require log analysis at the time of trouble can be preserved instead of allowing them to be lost.

### REFERENCE SIGNS LIST

10: Log display screen
100: System management server
104: Physical management server
105: Virtual management server
106: Storage management server
107: Blade server
109: Virtualization blade
112: Blade
113: Ether switch
115: FC switch
117: Storage device
302: Path ID
401: OS ID
500: Log
600: Tag management table

1. A computer system including a peripheral equipment and a blade server provided with a plurality of blades, which are physical machines, and a plurality of virtual machines available on the blades,
wherein a same OS identifier is allocated, before and after the migration, to an OS that migrates along with migration of the virtual machine, migrates among the plurality of virtual machines or migrates between the virtual machine and the blade, and
log of the blades and/or the virtual machines, and log of the peripheral equipment are stored in association with the OS identifier.

2. The computer system according to claim 1, wherein priority levels are assigned to the OS identifiers and, in deleting the stored logs, the logs are deleted in the ascending order of the priority levels assigned to the OS identifiers.

3. The computer system according to claim 2, wherein the priority levels are based on whether or not the OS is deleted, and log in association with OS identifier allocated to the deleted OS is deleted as highest priority level.

4. The computer system according to claim 2, wherein the priority levels are based on the number of migrations, and logs in association with OS identifiers allocated to the OSs with a smaller number of migrations are deleted as higher priority level.

5. The computer system according to claim 1, wherein upon acceptance of choice of the blade or the virtual machine, the OS identifier allocated to the OS having operated with the chosen blade or virtual machine is specified, and the log of the peripheral equipment in association with the specified OS identifier is outputted.

6. The computer system according to claim 1, wherein choice of the blade or the virtual machine is accepted and choice of the peripheral equipment type is also accepted, the OS identifier allocated to the OS having operated with the chosen blade or virtual machine is specified, and the log of the peripheral equipment in association with the specified OS identifier is outputted.

7. The computer system according to claim 1, wherein a reconfiguration identifier is allocated every time the blade and/or the virtual machine is reconfigured, and the log of the blade and/or virtual machine and the log of the peripheral equipment are stored in association with the reconfiguration identifier in addition to the OS identifier.

8. The computer system according to claim 7, wherein choice of the blade or the virtual machine is accepted and choice of the reconfiguration is also accepted, the OS identifier allocated to the OS having operated with the chosen blade or virtual machine is specified, the reconfiguration identifier allocated to the chosen reconfiguration is specified, and the log of the peripheral equipment in association with both the specified OS identifier and reconfiguration identifier is outputted.

9. A processing method of a computer system including a peripheral equipment and a blade server provided with a plurality of blades, which are physical machines, and a plurality of virtual machines available on the blades, the method comprising:
a step of allocating, before and after the migration, a same OS identifier to an OS that migrates along with migration of the virtual machine, migrates among the plurality of virtual machines or migrates between the virtual machine and the blade, and
a step of storing log of the blades and/or the virtual machines, and log of the peripheral equipment in association with the OS identifier.
